(19) United States
(12) Patent Application Publication
(10) Pub. No.: US 2009/0218854 A1
(43) Pub. Date: Sep. 3, 2009

(54) Planar Heating Element for a Motor Vehicle Seat

(75) Inventors: Karl Pfahler, Stuttgart (DE); Ina Von Szczepanski, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/091,703

(22) PCT Filed: Oct. 16, 2006
(86) PCT No.: PCT/EP2006/009956

§ 371 Date: Sep. 26, 2008

(30) Foreign Application Priority Data
Oct. 28, 2005 (DE) 102005051738.2

(51) Int. Cl. B60N 2/56

(52) U.S. Cl. 297/180.12; 219/553; 219/217; 219/202

(57) ABSTRACT

A planar heating element for a motor vehicle seat includes a plurality of heating conductors connected to at least one electrical contact conductor strip, which is to be joined to a power source. The contact conductor strip itself comprises an electrically conductive, nonwoven textile fabric.

This application is a National Stage of International Application No. PCT/EP2006/009956, filed Oct. 16, 2006 which claims priority under 35 U.S.C. §119 to German Patent Application No. 10 2005 051 738.2, filed Oct. 28, 2005, the entire disclosure of which is herein expressly incorporated by reference.

### BACKGROUND AND SUMMARY OF THE INVENTION

The invention relates to a planar heating element for a motor vehicle seat.

A planar heating element of this type, disclosed in German patent document DE 41 01 290 C2, comprises a plurality of heat conductors via which the seat or backrest surface facing the seat occupant is to be heated. In this case, the heat conductors are supplied with electric power via a contact conductor strip which is joined to a power source. For this purpose, a plurality of contact conductors in the form of sinusoidal or wavy strands, made, for example, of a carbon material, are fastened on the upper side of the contact conductor strip.

However, a disadvantage of the planar heating element described is the fact that the contact conductors are continually exposed to a very high load, particularly when a seat occupant gets in and out. Especially in the case of contact conductors made of carbon material, severe stressing of this type may lead to breaking or a material-induced overheating of the individual contact conductor.

It is therefore one object of the present invention to provide an improved planar heating element of the type mentioned previously, which withstand even high loads exerted by a seat occupant.

This and other objects and advantages are achieved by the planar heating element according to the invention, in which the contact conductor strip itself is designed as an electrically conductive, nonwoven textile fabric. A nonwoven textile fabric of this type is naturally nonrigid and accordingly can readily absorb high loads, such as occur, for example, when a seat occupant gets into and out of a motor vehicle seat. In this case, the contact conductor strip is designed to be sufficiently flexible both in the direction of extent and also transversely thereto.

In order to correspondingly supply the plurality of heat conductors with power, the contact conductor strip is of electrically conductive design. For this purpose, of the threads, yarns or the like of the nonwoven textile fabric can be designed from a correspondingly conductive material. Of course, it is likewise also possible merely to design portions of the threads, yarns or the like to be electrically conductive. All in all, however, a reliable supply of power to the plurality of heat conductors must be assured via the contact conductor strip. It is apparent that, by virtue of the invention, the provision, of the electrically conductive contact conductors or a non-conductive strip, heretofore required by the prior art, can be dispensed with.

In this case, a contact conductor strip which is designed as a nonwoven textile fabric fabricated in the form of a mesh has been shown to be particularly flexible. In particular, a drawn-loop knit or formed-loop knit has proven to be preferred here, since, use of a nonwoven fabric of this type which is fabricated in the form of a mesh achieves both good electrical contact connection between the individual meshes, and a very high degree of flexibility of the entire contact conductor strip.

In a further refinement of the invention, a nonwoven textile fabric, the threads, yarns or the like of which have portions of polyamide and portions of silver, has been shown to be advantageous. Such threads, yarns or the like are highly flexible and resistant to breakage, and are also very readily electrically conductive.

It has been shown to be furthermore advantageous to fasten the contact conductor strip to a base layer of the planar heating element by means of a textile connection. Since the contact strip has a high degree of flexibility, different contour profiles—matched to the contour of the seat or backrest surface of the vehicle seat—can be produced. In addition, the textile connection also provides a very good fastening of the contact conductor strip to the base layer, thereby withstanding high mechanical loads, for example when the seat occupant gets into and out of the vehicle seat. After the fastening of the at least one conductor strip to the base layer, the heat conductors can be fastened to the base layer by means of a stitched seam (particularly, a stitch-bonding seam). As a result, overall, a highly positionally precise and nevertheless flexible arrangement of the plurality of heat conductors on the base layer can be realized.

Finally, the arrangement of two contact conductor strips which run at the sides of the planar heating element and are covered by the heat conductors in order to form pressure contact points has been shown to be advantageous. The lateral arrangement of the contact conductor strips achieves an approximately equally rapid and uniform heating of the plurality of heat conductors, in all of the regions of the planar heating element. Power is supplied to the heat conductors in a technically simple manner by means of the pressure contact points formed between the heat conductors and the contact conductor strips.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic top view of a planar heating element with two laterally running contact conductor strips between which the heat conductors can be supplied with power;

FIG. 2 is a schematic illustration of the nonwoven textile fabric of the contact conductor strip, which fabric is designed as a drawn-loop knit, according to a first embodiment of the invention; and

FIG. 3 shows a schematic illustration of the nonwoven textile fabric of the contact conductor strip, which fabric is designed as a formed-loop knit, according to a further embodiment of the invention.

### DETAILED DESCRIPTION OF THE DRAWINGS

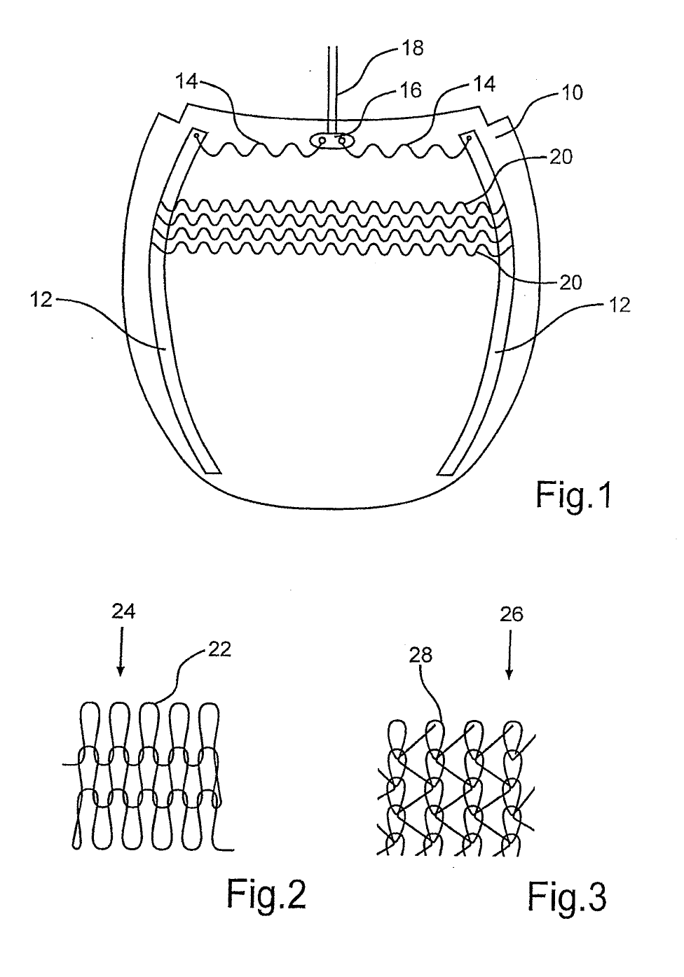

FIG. 1 is a top view of a planar heating element which can be arranged, for example, below a seat cover of a seat part or of a backrest part of a motor vehicle seat. For this purpose, the planar heating element is placed onto a lower layer (formed, for example, from foam) of the seat or backrest part, and is subsequently covered with a cover made of material or leather. Of course, the construction of the seat or backrest part may comprise further layers, such as, for example, a ventilation layer for ventilating the vehicle seat, or additional foam layers.

In the present exemplary embodiment, the planar heating element itself comprises a textile base layer 10 which is matched here to a seat surface of the motor vehicle seat. In this case, the textile base surface 10 can be formed from a single- or multi-layer textile, which may also include one or more layers made of foam in the form of a sandwich. Two contact conductor strips 12 are arranged at the sides of the base layer 10, which contact conductor strips, in the fitted state, run in the longitudinal direction of the motor vehicle seat or of the car and extend essentially over the entire length of the base layer 10. The contact conductor strips 12 here are designed as electrically conductive, nonwoven textile fabric and will be explained in more detail below in particular with reference to FIGS. 2 and 3.

In the present exemplary embodiment, the two contact conductor strips 12 are fixed to the textile base layer 10 by means of a textile connection. In the present exemplary embodiment, a stitched seam is provided as the textile connection. This makes it possible for the contact conductor strips 12 in the curved shape illustrated here—matched to the side cheeks of the seat surface of the motor vehicle seat—to be fixed permanently and in a dimensionally stable manner on the base layer 10.

The contact conductor strips 12 are connected at their front ends to power supply conductors 14 which are joined at the respectively other end to a power distributor 16. The power distributor 16 in turn is to be joined via a line 18 to a power source (not illustrated). In the present exemplary embodiment, the car electric system serves as the power source.

The two contact conductor strips 12 serve to supply power to a plurality of heat conductors 20, of which only three are indicated symbolically in FIG. 1. When power is supplied, the heat conductors 20 heat up and accordingly, if required, bring about the electric heating of the seat. In this case, the heat conductors 20 run over the entire direction of extent of the contact conductor strips 12 in a manner transversely with respect thereto.

In the present exemplary embodiment, the heat conductors 20 are produced from carbon fiber filaments which, firstly, are sufficiently flexible and, secondly, are very highly capable of conducting heat. The heat conductors 20 are fastened here on the base layer 10 by means of a stitch-bonding seam, and therefore they remain at least substantially in situ even under high mechanical loads, for example when a seat occupant gets in and out. The scope of the invention is also considered to include the fact that the heat conductors 20 may, of course, also be formed from a different material.

The lateral contact conductor strips 12 are covered by the heat conductors 20 in such a manner that pressure contact points arise between those regions of the contact conductor strips 12 which are arranged below and those regions of the heat conductors 20 which are arranged above. Accordingly, it is possible to transmit power reliably between the contact conductor strips 12 and the heat conductors 20 via said pressure contact points. It is apparent that, in particular in the region of the pressure contact points, the heat conductors 20 can be fastened to the contact conductor strips 12 with a particularly durable stitched seam or stitch-bonding seam.

In FIGS. 2 and 3, the construction of the nonwoven textile fabric of the contact conductor strips 12 is illustrated with reference to two exemplary embodiments. In the embodiment according to FIG. 2, the contact conductor strips 12 are illustrated as a nonwoven textile fabric which is fabricated in the form of a mesh and is in the form of a drawn-loop knit 24. In order to form the drawn-loop knit 24, the present exemplary embodiment uses a yarn 22 which has portions of polyamide and portions of silver. In other words, the yarn 22 is electrically conductive. Moreover, it is also apparent that, instead of the yarn 22 a thread, a wire, a filament or the like could be used. By forming the drawn-loop knit 24 illustrated here as a mesh, the contact conductor strips 12 are of correspondingly flexible and compliant design such that, as can be seen in FIG. 1, curved contour profiles are possible; in addition high durability is ensured in relation to mechanical loads, for example when a seat occupant gets in and out.

In the exemplary embodiment according to FIG. 3, the contact conductor strip is designed as a formed-loop knit 26 which is fabricated in the form of a mesh and is composed of a multiplicity of yarns 28. Of course, instead of the yarn 28, a thread, a wire, a filament or the like could be used.

The scope of the invention is considered to include the fact that, of course, not all of the threads, yarns, wires, filaments or the like of the drawn-loop knit 24 or of the formed-loop knit 26 need be electrically conductive. For example, it would also be possible to design just one portion of the threads, yarns, wires, filaments or the like to be electrically conductive. However, such portion must be of a size sufficient to ensure reliable guidance of power within the contact conductor strips 12. Furthermore, the scope of the invention is considered to include the fact that, instead of the two contact conductor strips 12, a plurality or just one may be provided and may be correspondingly fixed on the base layer 10.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-9. (canceled)

10. A heating element for a motor vehicle seat, said heating element comprising:
at least one electrical contact conductor; and
a two dimensional array comprising a plurality of heating conductors which are connected to the at least one electrical contact conductor strip, which is to be joined to a power source;
wherein the contact conductor strip comprises an electrically conductive, nonwoven textile fabric.

11. The heating element as claimed in claim 10, wherein the contact conductor strip comprises an electrically conductive element that is one of a thread, a yarn, a wire, and a filament.

12. The heating element as claimed in claim 10, wherein the contact conductor strip comprises a nonwoven textile fabric in the form of a mesh.

13. The heating element as claimed in claim 10, wherein the contact conductor strip comprises one of a drawn-loop net and a formed-loop net.

14. The heating element as claimed in claim 10, wherein the nonwoven textile fabric comprises strands which have portions of polyamide and portions of silver.

15. The heating element as claimed in claim 10, further comprising a base layer to which the contact conductor strip is fastened by a textile connection.

16. The heating element as claimed in claim 15, wherein the heat conductors are fastened to the base layer by a stitch-bonding seam.

17. The heating element as claimed in claim 10, wherein the heat conductors are made of carbon fiber filaments.

18. The heating element as claimed in claim 10, further comprising two contact conductor strips which run at the sides of the planar heating element and are covered by the heat conductors to form pressure contact points.
